(19) United States
(12) Patent Application Publication
(10) Pub. No.: US 2006/0009100 A1
(43) Pub. Date: Jan. 12, 2006

(54) Waterproofing membrane

(76) Inventor: Bryan McGroarty, Naples, FL (US)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(21) Appl. No.: 10/886,996

(22) Filed: Jul. 8, 2004

(51) Int. Cl. B32B 27/12; B32B 27/04

(52) U.S. Cl. 442/44; 442/2; 442/43; 442/42; 442/45; 442/149; 442/38

(57) ABSTRACT

A waterproofing membrane including a layer of bentonite that has sufficient flexibility to be bent upon itself 360° around a 0.5 inch radius. The layer of bentonite is preferably made of bentonite particles compacted to at least 25 pounds per square inch and held together by an adhesive matrix. The waterproofing membrane is preferably four layers, including a scrim, a first compacted layer of bentonite particles secured to the scrim, and a water permeable layer disposed on the first layer of bentonite particles and second layer of bentonite particles compacted and disposed on the water permeable layer. The bentonite particles may be used on a surface of a thermal insulating board to form a composite waterproofing and insulating structure.

### BACKGROUND OF THE INVENTION

The present invention relates to composite waterproofing sheets which include multiple layers with one or more layers of bentonite.

Bentonite (sodium monmorillonite) particles swell and gel in the present of water and are used in waterproofing sheets. Current bentonite containing waterproofing sheets are relatively heavy. In order to secure a waterproofing sheet to a vertical wall, it must be installed using concrete nails. The heavy weight of such sheets also requires significant manpower for installation. One reason for the heavy weight of such sheets is the large amount of granular bentonite material needed in order to attain sufficient internal pressure to effect a water seal. A typical roll of 96 square feet of bentonite sheeting averages 96 pounds. Such rolls are difficult to move around in construction job sites. Furthermore, shipping costs due to weight per square foot for such materials are also a consideration.

There are a number of patents which describe the use of bentonite in sheet material intended for waterproofing. These patents include the following: White U.S. Pat. Nos. 5,389,166, 5,237,945, 5,174,231, 5,346,565 and 5,346,566; Alexander U.S. Pat. Nos. 5,063,100, 5,053,265, 5,180,255, 5,187,915 and 5,112,665; Heerten U.S. Pat. Nos. Re 37,295 and 5,221,568; Starita et al. U.S. Pat. No. 5,725,942; Byrd U.S. Pat. No. 5,580,630; Kangas U.S. Pat. No. 5,473,848; Clem U.S. Pat. Nos. 4,467,015 and 4,501,788; Blaze U.S. Pat. No. 4,344,722; Crawford U.S. Pat. No. 4,565,468; Harriett U.S. Pat. Nos. 4,656,062 and 4,787,780; Shbakhman et al. U.S. Pat. No. 4,581,868; Randall U.S. Pat. No. 4,879,173; Klatt et al. U.S. Pat. No. 6,342,088; Weaver U.S. Pat. No. 3,943,032; McGroarty et al., U.S. Pat. Nos. 4,693,923, 5,079,088 and 5,091,234; McGroarty U.S. Pat. No. 4,837,085; and McGroarty U.S. Pat. No. 5,376,429.

### SUMMARY OF THE INVENTION

The present invention includes a waterproofing sheet comprising a scrim and two layers of bentonite particles with one layer being attached to the scrim and a water permeable layer disposed between the first and second layers of bentonite. In another aspect of the present invention, the layers of bentonite particles are compacted under a force of at least 25 pounds per square inch, and preferably 100 pounds per square inch. In another aspect of the present invention, the bentonite particles are held together with an adhesive and compacted such that the waterproofing sheet can be bent at least about 360° on a 0.5 inch radius. In a further aspect of the present invention, the waterproofing sheet is attached to a thermal insulating board providing waterproofing between itself and any adjacent board or between the board and whatever it is attached to.

### BRIEF DESCRIPTION OF THE DRAWINGS

FIG. 1 is a perspective view of a waterproofing membrane of the present invention.

FIG. 2 is perspective view of the waterproofing membrane attached to an insulating board.

FIG. 3 is a sectional view of a plurality of insulating boards and membranes secured to a wall.

FIG. 4 is a sectional view illustrating a method of joining two insulating boards of the present invention and securing them to a substrate.

FIG. 5 is a sectional view of a joint of FIG. 4 completed.

FIG. 6 is a sectional view illustrating an alternative embodiment of a joint of the present invention.

FIG. 7 is a perspective view of a method of attaching the waterproofing membrane to a corner of an insulating board.

FIG. 8 is a perspective view illustrating a plurality of insulating boards providing the waterproofing membrane in the joint between the insulating boards and in an overlapping relationship.

### DETAILED DESCRIPTION

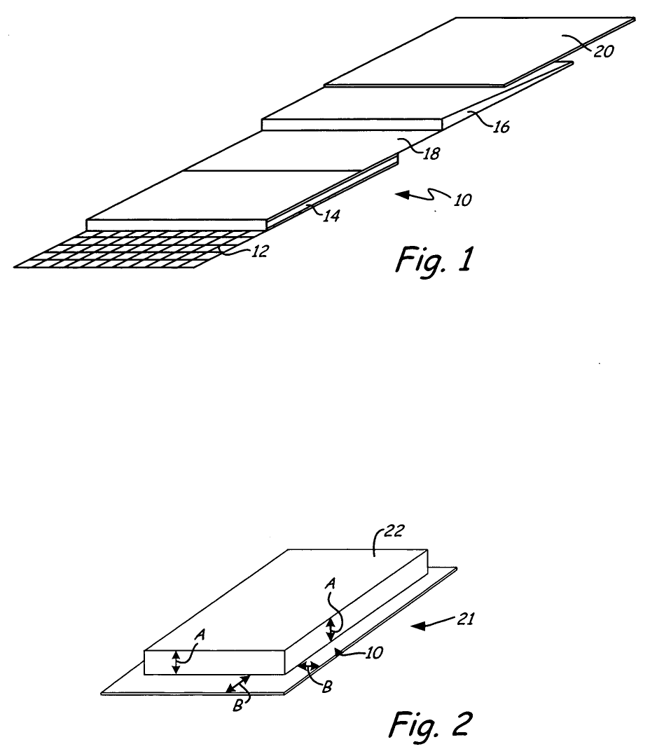

The present invention includes a four layer waterproofing membrane generally indicated at 10 in FIG. 1. Like reference characters will be used to indicate like elements throughout the drawings. The four layer waterproofing membrane 10 is approximately one half the weight of previous bentonite waterproofing membranes. In addition the membrane 10 of the present invention is flexible. The reduced weight of the waterproofing 10 membrane permits installation of the membrane without the use of dangerous nail guns or concrete nails since the membrane can be installed on vertical walls using adhesives instead of nails.

The four layers of the membrane include a porous woven layer 12, two flexible compressed bentonite layers 14 and 16, and a water permeable thin flexible membrane 18 disposed between the two bentonite layers 14 and 16. The membrane 18 may also be water impermeable membrane. Although each of the layers are distinct, the layers are integrated with each other to form an indivisible membrane 10.

The two bentonite layers 14 and 16 are almost solid, but yet flexible layers of bentonite formed by the compression of bentonite particles. Because of the bentonite compression, a relatively small amount of bentonite is needed to effect a water seal. Prior bentonite products are made of loosely adhered particles which required deep penetration of the intruding water before producing a water seal. Membrane 10 includes closely packed bentonite particles which do not require either deep penetration by water or large amounts of water to effect a water seal.

The primary reason for the reduction in the amount of bentonite in the present invention is that the bentonite particles are compressed (closely packed) in a manner heretofore not known before. The closely packed nature of the bentonite particles reduces the water permeability of the bentonite layer. The bentonite particles are compacted from an original size approximately no larger than 30 mesh and smaller than 50 mesh and reduced to a size ranging between 50 mesh and 100 mesh. Described in alternate fashion, the bentonite particles once compacted, occupy ½ to ⅔ of their original space. Such compaction requires less water to expand the bentonite sufficiently to form a water seal. Also less bentonite is needed to form the water seal since the bentonite does not have to expand as much to fill the voids between the bentonite particles.

The initial layer 14 of bentonite is placed on the porous woven layer 12. The porous woven layer 12 is a flexible woven fabric made of natural or synthetic material that is readily permeable by water and dimensionally stable in at least two directions. The porous woven layer acts as a reinforcing layer for the initial layer 14 of bentonite. The layer 12 is porous enough to allow bentonite to be embedded into the fabric but tight enough to retain the bentonite particles. In one example, the fabric comprises at least 90% of the total surface area of the layer with the remainder being holes for bentonite embedment.

The layer 12 also serves as the adhering layer for the membrane 10. The membrane 10 is secured with adhesive to a surface to be protected. The porous woven fabric should be strong enough to support the weight of the bentonite when the membrane of the present invention is secured vertically or to an overhead application. One example of a suitable fabric is a scrim or cheesecloth fabric with openings of 30 to 80 mesh with 40 mesh openings (United States standard mesh) as one preferred example. By scrim is meant any fabric having openings for bentonite particles to be embedded.

An ultra thin elastomeric film 18 is positioned between the two bentonite layers 14 and 16. The film 18 may be woven, braided or perforated to allow water to penetrate, thereby providing water access to both bentonite layers 14 and 16 and must be efficiently flexible or elastic to permit the membrane to be folded upon itself, in other words to be able to be bent virtually 360° about approximately a 0.5 inch radius. In another aspect of the present invention film 18 may be impermeable.

The bentonite that is preferred is sodium montmorillonite. The bentonite should have a low free silica content and preferably contain no material having a particle size larger than 20 mesh or smaller than 50 mesh. The moisture of the bentonite should not exceed 5% by weight and have less than 1% fines (particles smaller than 200 mesh).

A fifth layer 20 may be applied to the second layer 16 of bentonite. The composition of the fifth layer 20 depends on the final use of the membrane 10. The fifth layer 20 may be a protective water impermeable layer made of a solid plastic film such as polyethylene, polypropylene, polyvinyledene, EPDM, polyvinylchloride chloride butyl, flakes of polyethylene/propylene made from recycled material or glass, cellulosic or permeable polymer fiber adhered to the bentonite layer 16. The fifth layer when permeable is preferable when pre-adhering to sheets of insulation. This permeable layer would provide a good base for the subsequent adhesion to a wall. Such fifth layers are useful in an environment that includes long exposure to the elements or a damaging environment. The fifth layer may also be a water-repellent spray to prevent hydration when temporarily exposed to the elements.

In the fifth layer configuration, and when both outer layers include a scrim, the membrane 10 of the present invention the scrim provides a better bonding surface to the insulating board and the other side of the membrane then provides a better bonding surface to the surface to which the insulating board and the membrane is to be attached.

The membrane 10 is made by initially wetting the porous woven layer 12 with water. A layer 14 of bentonite particles is then applied to the porous woven layer 12. The bentonite particles positioned next to the porous layer 12 adhere to the layer 12 due to the wetness of the layer and the water absorbing properties of the bentonite. As the bentonite particles are deposited on the porous woven layer, the particles are sprayed with an adhesive in an amount sufficient to form fine adhesive filaments. Approximately 10 to 30% adhesive by weight in relation to the bentonite has been found to be a suitable amount of adhesive.

When the bentonite layer is compacted the adhesive binds the particles in a fibrous adhesive matrix to form an amalgamate in structure. The fibrous adhesive matrix provides flexibility to the bentonite layer such that the membrane is malleable and may be flexed for storing in roll form or the membrane conforms to non flat surfaces or has the ability to be folded upon itself or bent at least approximately 360° about an approximate 0.5 inch radius and preferably approximately 90° to conform to corners. Suitable adhesives need to be flexible and preferably elastomeric when cured or dried. The adhesives should also not affect the water absorbing properties of the bentonite to any great degree. A nonexhaustive list of suitable adhesives includes styrene butadiene, urea/formaldehyde, acrylics, nitriles, asphalts, butyl and natural rubbers or mixtures thereof. Suitable solvents for delivering the adhesives include aliphatic compounds, ketones, aldehydes, carbon/halides, toluene and other ring compounds and alcohols. Suitable water-soluble adhesives include saccharides, gums, tars, proteins and cellulosics.

The water permeable film 18 (FIG. 1) is then positioned over the bentonite layer 14. The adhesive used to hold the bentonite layer 14 secures the water permeable film 18 in place. The bentonite layer 14 is now compressed through a set of nip rollers.

A second layer 16 of bentonite particles is then placed on the water permeable film 18 and sprayed with adhesive in a manner similar to the formation of layer 14. The bentonite layer 16 is then compacted between a set of nip rollers.

The force used to compress is between about 1 pounds per square inch and 200 pounds per square inch and preferably between about 20 pounds per square inch and 100 pounds per square inch with the higher compressions providing the best results. When compacted the bentonite particles are actually crushed to a fine powder. The adhesive filaments hold the particles together making a dense particulate layer that has flexibility.

The membrane 10 of the present invention may also be used with a solid insulation board 22 to form a waterproofing/insulating composite as illustrated in FIG. 2. The solid board 22 of insulation must be waterproof such as extruded or sealed polystyrene or polyurethane. The insulating board must be impermeable to water and waterproof. By waterproof is meant impervious to or unaffected by water. The membrane 10 is secured using a suitable adhesive to the insulation board 22. In this situation the fifth layer 20 may be a loose mesh cheesecloth of approximately 60 mesh or an impermeable sheet adhered to the bentonite layer 16 or the expanded polystyrene insulation may be secured directly to the bentonite layer 16 with no fifth layer 20 in between.

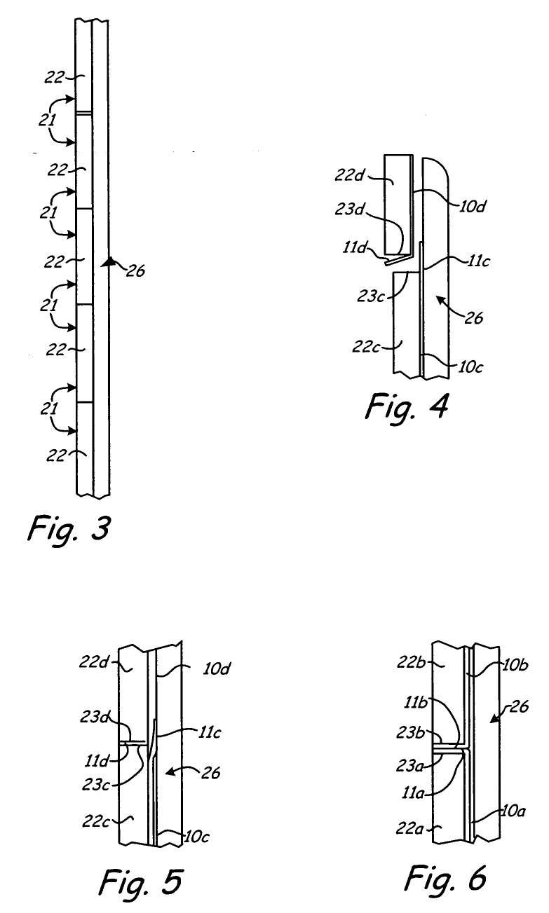

Conventional dimensions for extruded polystyrene insulating board are 8 feet by 4 feet by ½ to 2 inches thick. Polystyrene board is also made in other thickness less than ½ inch and greater than 2 inches. For purposes of an example, the membrane of the present invention is adhesively secured 8 feet by 4 feet by 2 inch thick to the extruded polystyrene board 22 in a 8 feet 4 inch by 4 feet 4 inch sheet so that in both the length and width directions, the membrane is not only secured to one major side surface of the polystyrene board but is also sufficiently large to cover the 2 inch thick side edges of the polystyrene board when folded upward during installation next to another board. Other thickness widths and lengths of extruded board are similarly accommodated by the thickness A of the board being substantially equal to the width B of the portions of the membrane that extend beyond the board. When the composite waterproofing/insulating board is secured to a wall 26, as illustrated in FIG. 3, the waterproofing/insulating board both insulates and provides waterproofing in one application.

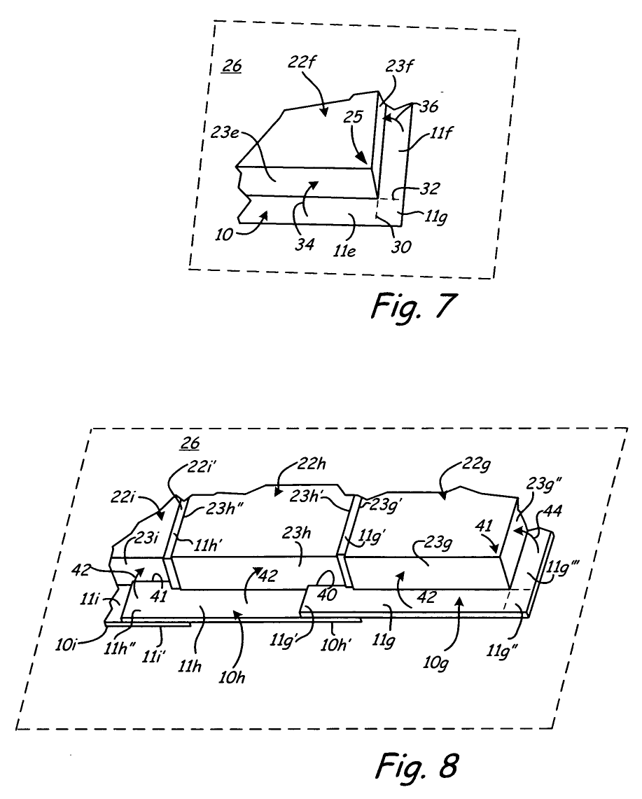

The membrane 10a and 10b may also be pre-attached to both the major surface and the sides 23a and 23b of the insulating boards 22a and 22b as illustrated in FIG. 6. Therefore when the insulating boards 22a and 22b are side by side, there will be two layers 11a and 11b of membranes 10a and 10b between adjacent insulating board sides 23a and 23b.

A plurality of composite insulating/waterproofing boards 21 are secured to the wall 26 as best illustrated in FIG. 3. Since the membrane 10 is secured to the side of the insulating board 22, the joint between insulating boards 22 includes at least one section of the membrane 10 overlying a side surface 23 of the insulating board 22 as best illustrated in FIGS. 4 and 5.

As illustrated in FIG. 4 and 5, in abutting insulating boards 22c and 22d, side section 11d of membrane 10d lies between the two side surfaces 23c and 23d of the insulating boards 22c and 22d. Section 11c of the membrane 10c is positioned to lie flat along the wall 26 to be protected overlapping the membrane 10d that is attached to the insulating board 22d. The side section 11d provides a swelling waterproofing layer between each insulating board thereby preventing water from seeping between the two boards. Furthermore, the overlapping section 11C of the membrane 10C provides a further seal between the boards 22C and 22D.

A method for covering side surfaces 23e and 23f proximate a corner 25 of the insulating board 22 is illustrated in FIG. 7. The membrane 10 is cut along broken lines 30 which lies along the plane of the side surface 23f and broken line 32 which lies along the plane of side surface 23e. The portion 11g of the membrane 10 after cuts are made along the broken lines is removed. Section 11e of the membrane 10 is then moved as indicated by arrow 34 abut against the side surface 23e of the board 22. Similarly, section 11f of the membrane 10 is moved as indicated by arrow 36 to abut against the side surface 23f of the board 22. The sections 11e and 11f may be adhesively secured to the respective side surfaces 23e and 23f of the insulating board 22.

A method is illustrated in FIG. 8 for insulating a wall structure 26. A plurality of insulating boards 22g, 22h and 22i having membranes 10g, 10h and 10i adhesively secured thereto and are positioned in an abutting relationship. The membranes 10g, 10h and 10i extend beyond side surfaces of each of the boards. Specifically illustrated are sections 11g, 11h and 11i which extend beyond the side surfaces 23g, 23h and 23i, respectively of the boards 22g, 22h and 22i whose side surfaces 23g, 23h and 23i are positioned along the same plane. Positioned between the insulating boards 22g and 22h is membrane section 11g′ which is positioned between side surfaces 23g and 23h′ of board 22h. Section 11g of the membrane 10g extends beyond side surface 23g and has a portion 11g′ which lies flat along a portion of side surface 23h in an overlapping relationship with portion 10h′ of section 10h by being cut along line 40. It will be understood that the portion 10h′ of section 10h is disposed underneath portion 11g′ of section 11g and such overlapping relationship between membranes 10g and 10h continues on beneath the entire length of the boards 22h and 22g.

Similarly, section 11h′ of the membrane 10h is positioned between side surface 23h″ and side surface 22i′ of boards 22h and 22i, respectively. The membrane 10h is cut along the line 41 so that portion 11h″ lies in an overlapping relationship with portion 11i′ of membrane 10i. Similarly, the portion 11i of membrane 10i that extends beyond the side surface 22i′ of the insulating board 22i lies in an overlapping relationship along the entire length of the membrane 10h. As indicated by arrows 42 the sections 11g, 11h and 11i along with their overlapping portions are moved to be adjacent the side surfaces 23g, 23h and 23i, respectively and are adhered thereto by suitable adhesive.

The corner 41 of the board 22g is attached to the membrane 10g in the same manner as described in FIG. 6. Sections 11g and 11g′″ are cut to produce corner portion 11g″ which is discarded. Section 11g′″ is moved in the direction of arrow 44 to position portion 11g′″ adjacent to the side surface 23g″ to which it can be adhesively secured.

The method described above provides a complete water seal with insulating capabilities to a wall or overhead structure. A section of waterproofing membrane is disposed between each insulating board and the membranes overlap each other along the entire length of the membranes. The method permits subsequent placement of insulating board along with membrane in any direction resulting in the membrane overlapping the insulating boards and a section of the membrane being positioned between the boards. Thus a waterproofing seal is affected along the perimeter of each insulting board and also between the board and the wall to be protected. The membrane provides a waterproof seal on both surfaces of the membrane. Each insulating board (and the surface to be protected) is therefore protected from water intrusion along its sides and between insulating boards.

The present invention has water protected insulation that truly insulates since the insulation is waterproofed by the bentonite membrane under and around each insulating board. If water were to pass under or around the insulating board, it would negate the insulating effect of the board.

Although the present invention has been described with reference to preferred embodiments, workers skilled in the art will recognize that changes may be made in form and detail without departing from the spirit and scope of the invention.

What is claimed is:

1. A waterproofing sheet comprising:
a layer of bentonite secured to a scrim and compacted utilizing a pressure of at least 25 pound per square inch.

2. The waterproofing sheet of claim 1 wherein the bentonite is compacted at a pressure of at least 75 pounds per square inch.

3. The waterproofing sheet of claim 1 wherein the bentonite includes bentonite particles and further including an adhesive interspersed within the bentonite particles in an amount to effectively retain the bentonite particles in an integral layer.

4. The waterproofing sheet of claim 3 wherein the adhesive is in an amount between 10 to 30% by weight.

5. The waterproofing sheet of claim 3 wherein the adhesive is in the form of a filament structure within the bentonite particles.

6. A waterproofing sheet comprising:
a scrim;
a first layer of bentonite particles disposed on the scrim;
a second layer of bentonite particles adjacent the first layer of bentonite particles; and
a water permeable or impermeable layer disposed between the first and second layers of bentonite particles.

7. The waterproofing sheet of claim 6 wherein the bentonite particles are compressed with a pressure of at least approximately 25 pound per square inch.

8. The waterproofing sheet of claim 7 wherein the bentonite particles are compressed with a pressure of at least approximately 75 pounds per square inch.

9. The waterproofing sheet of claim 6 wherein the bentonite particles are bound by an adhesive.

10. The waterproofing sheet of claim 9 wherein the adhesive is in the approximate range of approximately 10 to 30% by weight.

11. The waterproofing sheet of claim 9 wherein the adhesive is interspersed in the bentonite particles such that the sheet is sufficiently flexible to bend up to approximately 360° around approximately 0.5 inch radius.

12. A waterproofing structure comprising:
a thermal insulating board;
an amalgamated layer of bentonite particles secured to the insulating board.

13. The waterproofing structure of claim 12 wherein the insulating board has a length and a width defining a major surface and a thickness that defines a side surface, and wherein the amalgamated layer of bentonite particles extends beyond the selected length and width of the major surface.

14. The waterproofing structure of claim 13 wherein the amalgamated layer of bentonite particles has sufficient malleability to be flexed for being positioned proximately adjacent the side surface.

15. A waterproofing structure comprising:
a thermal insulating board;
a waterproofing membrane including a layer of bentonite, the waterproofing membrane is attached to the insulating board.

16. The waterproofing structure of claim 15 wherein the waterproofing membrane comprises:
a scrim; and
a first layer of bentonite particles attached to the scrim.

17. The waterproofing structure of claim 16 wherein the membrane further includes:
a second layer of bentonite particles adjacent the first layer of bentonite particles; and
a water permeable or impermeable layer disposed between the first and second layers of bentonite particles.

18. The waterproofing structure of claim 15 wherein the bentonite particles are compressed with a pressure of at least approximately 25 pound per square inch.

19. The waterproofing structure of claim 18 wherein the bentonite particles are compressed with a pressure of at least approximately 75 pounds per square inch.

20. The waterproofing structure of claim 15 wherein the bentonite includes bentonite particles bound with an adhesive.

21. The waterproofing structure of claim 20 wherein the adhesive is in the range of approximately 10 to 30% by weight of the bentonite particles.

22. The waterproofing structure of claim 20 wherein the adhesive is interspersed in the bentonite particles providing the sheet with sufficient malleability to be bent up to approximately 360° about an approximate 0.5 in radius.

23. The waterproofing structure of claim 15 wherein the membrane is bendable and extends sufficiently beyond the width and length of the major surface to cover at least a portion of the side surface.

24. A waterproofing arrangement comprising;
a plurality of waterproofing structures secured to a surface to be protected and to be insulated;
each structure comprising:
a thermal insulating board;
a waterproofing membrane including a layer of bentonite, the waterproofing membrane being attached to the insulating board.

25. The waterproofing arrangement of claim 24 wherein the waterproofing membrane comprises:
a scrim; and
a first layer of bentonite particles attached to the scrim.

26. The waterproofing arrangement of claim 25 wherein the membrane further includes:
a second layer of bentonite particles adjacent the first layer of bentonite particles; and
a water permeable layer disposed between the first and second layers of bentonite particles.

27. The waterproofing arrangement of claim 24 wherein each of the water proofing structures are in an adjoining relationship when secured to the surface to be protected and wherein a portion of the waterproofing membrane is disposed between each waterproofing structure.

28. The waterproofing arrangement of claim 27 wherein the waterproofing membrane of adjacent structures extends over the waterproofing membrane of another structure.

29. A method of forming a waterproofing membrane, the method comprising:
providing a scrim;
wetting the scrim with an aqueous solution;
depositing bentonite particles in a layer on the scrim; and
compacting the layer of bentonite particles with at least 25 pounds per square inch to form a layer of bentonite particles embedded within the scrim.

30. The method of claim 29 and further comprising spraying an adhesive onto the particles prior to compaction.

31. The method claim 29 and further comprising:
depositing a flexible permeable film onto the first layer of bentonite particles;

32. The method of claim 31 and further comprising:
depositing a second layer of bentonite particles onto the flexible film;
compacting the second layer of bentonite particles.

33. A method of constructing a waterproofing arrangement secured to a surface to be protected, the method comprising:
providing a plurality of waterproofing structures, each waterproofing structure have a thermal insulating board and a waterproofing membrane attached thereto; and
securing the waterproofing structures in a side by side relationship such that the waterproofing membranes of the waterproofing structures form a substantially contiguous water barrier.

34. The method of claim 33 wherein the membrane extends beyond a major surface of the insulating board and positioning portions of the membrane extending beyond the insulating board along the sides of the insulating board to provide waterproofing membrane between adjacent insulating boards.

35. The method of claim 33 and further comprising:
positioning the membranes of the waterproofing structures in an overlapping relationship.
